(19) United States
(12) Patent Application Publication
(10) Pub. No.: US 2021/0047072 A1
(43) Pub. Date: Feb. 18, 2021

(54) CONSUMER PRODUCT

(71) Applicant: The Procter & Gamble Company, Cincinnati, OH (US)

(72) Inventors: Clara Sophie NG PAK LEUNG, Ixelles (BE); Paulus Antonius Augustinus HOEFTE, Astene (BE); Joost LEFLERE, Mechelen (BE); Alberto MARTINEZ-BECARES, Brussels (BE)

(21) Appl. No.: 16/988,767

(22) Filed: Aug. 10, 2020

(30) Foreign Application Priority Data
Aug. 14, 2019 (EP) 19191699.8
Aug. 14, 2019 (EP) 19191707.9
Aug. 5, 2020 (EP) 20189610.7
Aug. 6, 2020 (EP) 20189797.2

(51) Int. Cl. B65D 5/68; C11D 17/04; B65D 5/38; B65D 5/468

(52) U.S. Cl. CPC B65D 5/685; B65D 5/4608; B65D 5/38; C11D 17/045

(57) ABSTRACT

Consumer product that includes a container and at least one water-soluble unit dose article.

### FIELD OF THE INVENTION

Consumer product comprising a container and at least one water-soluble unit dose article.

### BACKGROUND OF THE INVENTION

Water-soluble unit dose articles are liked by consumers due to their convenience and ease of use. Without wishing to be bound by theory, water-soluble unit dose articles comprise a water-soluble film shaped to form at least one internal compartment which houses a single use dose of a detergent. Upon addition of the water-soluble unit dose article to water, the water-soluble film dissolves and/or disintegrates releasing the detergent into the surrounding water to produce a wash liquor.

Such water-soluble unit dose articles are stored and transported in rigid or flexible plastic containers. Without wishing to be bound by theory, consumers purchase containers comprising a plurality of water-soluble unit dose articles. The containers are shipped from the place of manufacture to supermarkets and once purchased are stored in consumers' homes.

An issue is during transport and storage the container comprising water-soluble unit dose articles can be subjected to extreme variations in temperature. Such environmental changes can as such result in structural failure of the water-soluble unit dose article. Structural failure can result in the unit dose article prematurely rupturing and leaking the internal contents. Such leaked content can hence further contaminate other water-soluble unit dose article co-stored in the container. A further issue is that such environmental changes can also result in multiple water-soluble unit dose articles sticking together, causing inconvenience to the consumer having to re-separate them prior to dosing, and in a worse case even causing structural failure of the water-soluble unit dose article upon efforts to separate them.

A further issue is the containers may accidentally prematurely open during transport. This premature opening can not only lead to water-soluble unit dose articles moving out of the storage container but can also result in additional exposure of the water-soluble unit dose articles to variations in environmental conditions including strong temperature variations, in addition to contamination of the other enclosed water-soluble unit dose articles. Therefore, such containers comprise latches to ensure they remain closed until intentionally opened.

Therefore, there is a need for a consumer product comprising a water-soluble unit dose article wherein the incidents of structural failure as a consequence of extreme temperature variations of said water-soluble unit dose articles is reduced during transport and storage, wherein the consequence of an incidental structural failure of a single water-soluble unit dose article on other enclosed water-soluble unit dose articles is minimized, and also ensuring accidental premature opening is minimized. It was surprisingly found that a consumer product according to the present invention overcomes the above problem.

### SUMMARY OF THE INVENTION

The present disclosure relates to a consumer product comprising at least one water-soluble unit dose article and a container; wherein the at least one water-soluble unit dose article comprises at least one water-soluble film orientated to create at least one unit dose internal compartment, wherein the at least one unit dose internal compartment comprises a detergent composition; and wherein the container comprises a first part, wherein the first part comprises a first compartment in which the at least one water-soluble unit dose article is contained, and wherein the first compartment is accessible through a first opening; and wherein the container comprises a second part, wherein the second part is positioned so that it prevents access through the first opening when the container is not in use, but is moveable to allow access to the first opening when the container is in use; and wherein the container comprises a locking means wherein the locking means comprises a first locking component on the first part and a second locking component on the second part, wherein the first locking component engages the second locking component to prevent movement of the second part to allow access to the first opening until the first locking component and second locking component are disengaged from one another by a user; and

wherein the first part comprises an interior surface and an exterior surface, wherein the interior surface faces the internal compartment; and wherein at least part of the interior surface of the first part is constructed from paper-based material so that the water-soluble film of the at least one unit dose article directly contacts the paper-based material of the internal surface.

### BRIEF DESCRIPTION OF THE DRAWINGS

FIG. 1 depicts a consumer product (1) comprising at least one water-soluble unit dose article (not shown) and a container (2) according to the present invention.

FIGS. 2A, 2B and 2C depict a cross sectional view of the container (2) of FIG. 1

FIG. 3 depicts a consumer product (1) as according to FIG. 1 but wherein the second part (4) is connected to the first part (3) via a hinge (21).

FIG. 4 depicts an alternative example according to the present invention.

FIG. 5 depicts the container according to FIG. 4 in an open position.

FIG. 6 depicts the first part (3) of FIGS. 4 and 5 completely removed from the second part (4).

FIG. 7 depicts a first part (3) according to FIG. 5 but having a larger first opening (6).

FIG. 8 depicts a top cross-sectional view of the second part (4) according to FIG. 4.

FIG. 9 depicts a 3D representation of the second part (4) according to FIG. 4

FIGS. 10A and 10B depict a cross-sectional view of the consumer product (1) according to FIG. 4.

FIG. 11 depicts a consumer product (1) as according to FIGS. 4-9, 10A and 10B but wherein the second locking component (8) is in a different location.

FIG. 12 discloses a water-soluble unit dose article according to the present invention.

### DETAILED DESCRIPTION OF THE INVENTION

### Consumer Product

The present invention is to a consumer product comprising at least one water-soluble unit dose article and a container. The water-soluble unit dose article and the container are described in more detail below.

The consumer product can be sold ‘as is’, in other words the consumer product is the item that the consumer picks up from the shelf. Alternatively, the consumer product could be housed as one unit of a multi-component product. For example, more than one consumer product could be housed within an outer package and the multiple packaged consumer products sold together in a single purchase.

The consumer product may comprise aesthetic elements, for example shrink sleeves or labels attached to the container. Alternatively, the container may be coloured or printed with aesthetic elements or informative print such as usage instructions.

### Water-Soluble Unit Dose Article

The at least one water-soluble unit dose article comprises at least one water-soluble film orientated to create at least one unit dose internal compartment, wherein the at least one unit dose internal compartment comprises a detergent composition. The water-soluble film and the detergent composition are described in more detail below.

The consumer product comprises at least one water-soluble unit dose article, preferably at least two water-soluble unit dose articles.

A water-soluble unit dose article is generally in the form of a pouch. It comprises a unitary dose of a composition as a volume sufficient to provide a benefit in an end application.

The water-soluble unit dose article comprises at least one water-soluble film shaped such that the unit-dose article comprises at least one internal compartment surrounded by the water-soluble film. The at least one compartment comprises a cleaning composition. The water-soluble film is sealed such that the cleaning composition does not leak out of the compartment during storage. However, upon addition of the water-soluble unit dose article to water, the water-soluble film dissolves and releases the contents of the internal compartment into the wash liquor.

The unit dose article may comprise more than one compartment, even at least two compartments, or even at least three compartments, or even at least four compartments, or even at least five compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

Each individual unit dose article may have a weight of between 10 g and 40 g, or even between 15 g and 35 g.

The film of the present invention is soluble or dispersible in water. Prior to be being formed into a unit dose article, the water-soluble film preferably has a thickness of from 20 to 150 micron, preferably 35 to 125 micron, even more preferably 50 to 110 micron, most preferably about 76 micron.

Preferred film materials are preferably polymeric materials. The film material can, for example, be obtained by casting, blow-moulding, extrusion or blown extrusion of the polymeric material, as known in the art.

Preferably, the water-soluble film comprises polyvinyl alcohol polymer or copolymer, preferably a blend of polyvinylalcohol polymers and/or polyvinylalcohol copolymers, preferably selected from sulphonated and carboxylated anionic polyvinylalcohol copolymers especially carboxylated anionic polyvinylalcohol copolymers, most preferably a blend of a polyvinylalcohol homopolymer and a carboxylated anionic polyvinylalcohol copolymer.

Preferably, the water-soluble film comprises a polymer wherein the polymer comprises a homopolymer, copolymer, or mixture thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, xanthum, carragum or a mixture thereof, preferably, polyvinylalcohol homopolymers and/or anionic polyvinylalcohol copolymers preferably selected from sulphonated and carboxylated anionic polyvinylalcohol copolymers especially carboxylated anionic polyvinylalcohol copolymers.

Preferred films are those supplied by Monosol under the trade references M8630, M8900, M8779, M8310.

The film may be opaque, transparent or translucent. The film may comprise a printed area.

The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 ppm.

The water-soluble film or water-soluble unit dose article or both may be coated with a lubricating agent. Preferably, the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

### Container

The consumer product comprises a container. The container comprises a first part, wherein the first part comprises a first compartment in which the at least one water-soluble unit dose article is contained. Preferably the first compartment comprises at least two water-soluble unit dose articles. The first compartment may comprise between 1 and 80 water-soluble unit dose articles, or even between 1 and 60 water-soluble unit dose articles, or even between 1 and 40 water-soluble unit dose articles, or even between 1 and 20 water-soluble unit dose articles. The volume of the first compartment may be between 500 ml and 5000 ml, preferably between 800 ml and 4000 ml.

The first compartment is accessible through a first opening. Those skilled in the art will be aware of a suitable size for the first opening. Without wishing to be bound by theory, the first opening should be of sufficient size to retrieve at least a single water-soluble unit dose article at a time. Alternatively, the first opening may be shaped to allow the unit dose articles to be poured out from the container. Therefore, it should be dimensioned to be big enough for at least a single unit dose article to fit through the first opening. Preferably, the first opening should be big enough for a user to fit their hand through to retrieve at least one water-soluble unit dose article.

The container comprises a second part, wherein the second part is positioned so that it prevents access through the first opening when the container is not in use, but is moveable to allow access to the first opening when the container is in use. Without wishing to be bound by theory, the first part and the second part are able to move relative to one another. This relative movement allows the second part to block entry to the first opening when not in use, but then allow access to the first opening when in use. Without wishing to be bound by theory, the user controls the movement of the first and second parts relative to one another to achieve this.

The movement of the first part and the second part relative to one another can be achieved via any suitable means. Those skilled in the art will be aware of suitable means. The first part may slide within the second part. Alternatively, the second part may act as a lid to the first part. The lid may be hinged to the first part or may be completely separated from the first part. Preferably, the second part comprises a top wall and at least one side wall, and the first part comprises a base wall and the first opening, wherein the first opening is opposite to the base wall and the base wall and the first opening are connected by at least one side wall. In the closed position the at least one side wall of the second part overlaps at least partially within the one side wall of the first part. In other words, the second part acts as a hood positioning over the first part and so blocking access to the first opening. Alternatively, in the closed position the at least one side wall of the first part overlaps at least partially within the one side wall of the second part, in other words, the second part slots inside the first opening blocking access to the first opening.

The container further comprises a locking means. The locking means comprises a first locking component on the first part and a second locking component on the second part. The first locking component engages the second locking component to prevent sufficient movement of the second part relative to the first part to allow access to the first opening, until the first locking component and second locking component are disengaged from one another by a user. Those skilled in the art will be aware of suitable locking means to achieve this. A preferred locking means is where the first locking component comprises a tab and the second locking component comprises an abutment against which the tab abuts when in the closed position. The abutment may simply comprise a surface against which the tab abuts. Alternatively, the abutment comprises a slot or pocket capable of receiving the tab when in the locked position. Preferably, the first locking component is a tab that protrudes from the exterior surface of the first part and the second part comprises an abutment against which the first locking tab is able to releasably engage.

The container may comprise more than one locking means. The container may comprise two locking means. The locking means may be orientated to be opposite one another on the container, such that the consumer can hold the container and using a thumb and a finger to open both locking means simultaneously. Preferably, wherein the locking means are opposite to one another the container is of an appropriate dimension to allow the user, especially an adult user, to grip the container with one hand and simultaneously open both locking means using the thumb and a finger of the other hand. When the container comprises at least two locking means, preferably the two locking means are spaced apart by a distance of between 70 mm and 150 mm, more preferably between 80 mm and 120 mm Without wishing to be bound by theory such distance allows for the adult human handspan to ergonomically fit around the container to allow simultaneous disengagement of the two locking means.

Preferably both locking means comprise a first locking component on the first part and a second locking component on the second part. Preferably the first locking means and second locking means both comprise tabs on the first part and abutments on the second part.

The first part comprises an interior surface and an exterior surface, wherein the interior surface faces the internal compartment. At least part of the interior surface of the first part is constructed from paper-based material so that the water-soluble film of the at least one unit dose article directly contacts the paper-based material of the internal surface. In other words, at least one water-soluble unit dose article housed within the container will be in direct contact with the paper-based material. During storage and transport, the water-soluble unit dose article may move within the container, however, there is no impendent between the water-soluble unit dose article and the paper-based material, except for other water-soluble unit dose articles.

By paper-based material, we herein mean a material comprising paper. Without wishing to be bound by theory, by ‘paper’ we herein mean a material made from a cellulose-based pulp. Preferably, the paper-based material comprises paper, cardboard, or a mixture thereof, wherein preferably, cardboard comprises paper-board, corrugated fibre-board, or a mixture thereof. The paper-based material may comprise a printed image thereon.

Preferably, the entire interior surface of the first part is constructed from a paper-based material, more preferably, the whole of the first part is constructed from a paper-based material.

Preferably, the second part comprises an interior surface and an exterior surface. Preferably, at least part of the interior surface of the second part is constructed from a paper-based material, preferably the entire interior surface of the second part is constructed from a paper-based material, even more preferably, the entire second part is constructed from a paper-based material.

Preferably, the first locking component is constructed from a paper-based material or the second locking component is constructed a paper-based material or a combination thereof.

The paper-based material may be a laminate comprising paper, cardboard, or a mixture thereof, wherein preferably, cardboard comprises paper-board, corrugated fibre-board, or a mixture thereof, and at least a second material. Wherein the paper-based material is a laminate, then the internal surface of the first part and preferably the internal surface of the second part comprises paper, cardboard, or a mixture thereof, wherein preferably, cardboard comprises paper-board, corrugated fibre-board, or a mixture thereof, and preferably the external surface of the first part, external surface of the second part or a mixture thereof comprises the second material. Alternatively, the second material might also be laminated in-between two paper-based material layers.

The first locking component may be a tab made from corrugated fibre-board. Without wishing to be bound by theory, corrugated fibre-board comprises a series of flutes. Each flute can be understood to be a channel. The flutes run parallel to one another, with the flute direction being the direction travelled along each channel. Preferably, the tab comprises a fold which runs perpendicular to the flute direction. Such folding of the tab results in the tab being capable of returning to its original position, in other words having a memory property to allow it to spring back. This is preferably so that it can re-engage efficiently with the second locking component on subsequent use.

Alternatively, the first locking component may be a tab made from paper-board. Without wishing to be bound by theory, paper-board comprises fibres running in the fibre direction, wherein the fibre direction should be understood to be the direction along the longest dimension of the fibres. Preferably, the tab comprises a fold which runs perpendicular to the fibre direction. Such folding of the tab results in the tab being capable of returning to its original position, in other words having a memory property to allow it to spring back. This is preferably so that it can re-engage efficiently with the second locking component on subsequent use.

Those skilled in the art will be aware of suitable second materials. Preferably, the second material comprises a plastic material. Preferably, the plastic material comprises polyethylene, polyethylene terephthalate, polypropylene, polyvinylalcohol or a mixture thereof. The barrier material may be a biaxially orientated polypropylene, a metallised polyethylene terephthalate or a mixture thereof. Alternatively, the second material may be a wax, a cellulose material, polyvinylalcohol, or a mixture thereof.

Preferably, the paper-based laminate comprises greater than 50%, preferably greater than 85%, and more preferably greater than 95% by weight of the laminate of fibre-based materials. Preferably, the plastic material has a thickness of between 10 micron and 40 micron, more preferably between 10 micron and 35 micron.

Preferably, the second part is a sleeve that receives the first part therein and the first part is able to slide within the second part between an open position in which the first opening is accessible and wherein the first locking component and second locking component are disengaged from one another in a closed position in which the second part blocks access to the first opening when the first locking component and the second locking component are engaged.

Alternatively, preferably, the first part comprises a base wall and the first opening, wherein the first opening is opposite to the base wall and the base wall and the first opening are connected by at least one side wall, and the second part comprises a second opening and at least one connecting wall, wherein the first part slides within the second part via the second opening and the connecting wall blocks the first opening when in the closed position. In this preferred option, the at least one side wall of the first part comprises the first locking component and the at least one connecting wall of the second part comprises the second locking component. Preferably, the second part comprises an end wall opposite to the second opening and the second opening and the end wall are connected via the at least one connecting wall.

The connecting wall has an inside surface and an exterior surface. The inside surface faces the first part and the exterior surface faces the exterior environment to the container.

The second locking component may be an abutment formed by cutting a portion of the connecting wall and folding said portion back upon itself and then adhering said folded back portion to the inside surface of the connecting wall to create the abutment. The cut portion of the connecting wall forms the opening of the second locking component. Alternatively, wherein the second locking component is an abutment, it may be formed by adhering a separate piece of material, preferably wherein the separate piece of material is selected from paper, cardboard, or a mixture thereof, to the inside surface of the connecting wall.

The container may comprise stopper means to prevent the first part from being completely removed from the second part. Such stopper means may comprise a stopper abutment on the second part which interacts with the first locking component, preferably wherein the first locking component is a tab, preventing further movement of the first part when being slid out of the second part during use. Without wishing to be bound by theory, when the first locking component is disengaged from the second locking component, the first part and second part can be moved relative to one another. During movement, the first locking component then abuts against the stopper abutment preventing any further movement. Alternatively, the stopper means may comprise a stopper tab, separate to the first locking component, that abuts against the second locking means. In this instance, without wishing to be bound by theory, after disengagement of the first locking component and the second locking component, the first part and second part can be moved relative to one another, and the stopper tab abuts against the second locking means preventing any further movement.

The stopper means may be formed by folding back the end of the connecting wall and adhering the folded back part to the inside surface of the connecting wall. The end of the connecting wall should be understood to mean the edge of the connecting wall forming the second opening. Alternatively, the stopper means may be formed by adhering a separate piece of material, preferably wherein the separate piece of material is selected from paper, cardboard, or a mixture thereof, to the inside surface of the connecting wall.

Alternatively, the second part is a removable lid, wherein the second part in a closed position blocks access to the first opening and when in a closed position the first locking component is engaged with the second locking component, and when in an open position the first locking component and second locking component are disengaged and the second part is removable to allow access to the first opening. Preferably, the second part is attached to the first part via a hinge or the second part can be completely removed from the first part. Preferably, the second part can be completely removed from the first part.

Preferably, the second part comprises a top wall and at least one side wall, and the first part comprises a base wall and the first opening, wherein the first opening is opposite to the base wall and the base wall and the first opening are connected by at least one side wall. In the closed position the at least one side wall of the second part overlaps at least partially within the one side wall of the first part. In this preferred example, the first locking component is positioned on the at least one side wall of the first part and second locking component is positioned on the at least one side wall of the second part.

The at least one side wall of the second part has an inside surface and an exterior surface. The inside surface faces the first part and the exterior surface faces the exterior environment to the container. Alternatively, in a less preferred option, in the closed position the at least one side wall of the first part overlaps at least partially within the one side wall of the second part.

The second locking component may be an abutment formed by cutting a portion of the at least one side wall of the second part and folding said portion back upon itself and then adhering said folded back portion to the inside surface of the at least one side wall of the second part to create the abutment. The cut portion of the at least one side wall of the second part forms the opening of the second locking component. Alternatively, wherein the second locking component is an abutment, it may be formed by adhering a separate piece of material, preferably wherein the separate piece of material is selected from paper, cardboard, or a mixture thereof, to the inside surface of the at least one side wall of the second part. Alternatively, wherein the second locking component is an abutment, the second locking component may be formed by folding the end of the at least one wall of the second part back upon itself and then adhering the folded portion to the inside surface of the at least one wall of the second part.

### Detergent Composition

The detergent composition may be a laundry detergent composition, an automatic dishwashing composition, a hard surface cleaning composition, or a combination thereof. The detergent composition may comprise a solid, a liquid or a mixture thereof. The term liquid includes a gel, a solution, a dispersion, a paste, or a mixture thereof.

The solid may be a powder. By powder we herein mean the detergent composition may comprise solid particulates or may be a single homogenous solid. Preferably, the powder detergent composition comprises particles. This means the powder detergent composition comprises individual solid particles as opposed to the solid being a single homogenous solid. The particles may be free-flowing or may be compacted, preferably free-flowing.

Preferably, the detergent composition is a laundry detergent composition, most preferably a liquid laundry detergent composition.

The laundry detergent composition can be used in a fabric hand wash operation or may be used in an automatic machine fabric wash operation, preferably an automatic machine fabric wash operation.

Preferably, the detergent composition is a perfumed detergent composition. By ‘perfumed detergent composition’ we mean that free perfume has been added to the detergent composition. By ‘free perfume’ we herein mean perfume compounds are added directly to the detergent composition and are not present on encapsulates or on carrier materials. The composition might also comprise secondary perfume sources such as perfume capsule and/or pro-perfume e.g. perfume bound to a carrier material technology. Those skilled in the art will know of possible free perfumes to be formulated inside a liquid laundry detergent composition to be formulated inside a water soluble unit dose article. These free perfume compositions are composed of a broad range of individual perfume raw materials which are carefully balanced to create a desired perfumed character, perfume deposition and perfume longevity profile, and this across the different stages of the wash and wear process, e.g. upon dosing of the detergent composition, upon removal of the wet fabrics from the laundry washing machine or upon hand-washing, upon line-drying or at the end of tumble drying process, upon storage of the fabrics in consumers' wardrobe and upon wearing the fabrics. This balanced selection of individual perfume materials typically considers, in addition to the perfume character of an individual raw material, also its polarity, volatility and perceived intensity. The detergent composition preferably comprises between 0.01 and 10%, preferably between 0.1% and 5%, more preferably between 0.5% and 3% of free perfume. In addition to free perfume also a secondary source of perfume can be present, more particularly the detergent composition might also comprise encapsulated perfumes or pro-perfume technologies, or a mixture thereof.

Without wishing to be bound by theory, an issue is during transport and storage perfume will partially migrate from the detergent composition through the water-soluble film and start building up in the headspace of the container. Some consumers, however, do not like strong perfumes applied to their clothes, e.g. they desire minimum perfume application, purely as a sign that their clothes are clean and refreshed but do not want to experience an “overwhelming” perfume. To them, a strong perfume headspace build up in the tub is undesired as it is perceived as a signal that during washing also a strong perfume will be applied to their clothes. Even when formulating a “light” perfume targeting this consumer segment the perfume build-up in the headspace experience is still to be improved.

A possible solution could be for the consumer to store the containers in an open position such that a perfume headspace cannot build up. This is undesired however, as it will increase the sensitivity of the water-soluble unit dose article to external humidity conditions as well as the risk of accidently contaminating the water-soluble unit dose articles. More importantly, while keeping the container open would reduce the risk of strong perfume build up in the storing container, this approach will not provide the consumer a reassuring signal that the detergent composition is not comprising a strong perfume. He/she will not know as there would not be a perfumed headspace based on which the consumer can judge whether the formulated perfume would match his/her need. Therefore, the consumer prefers such containers comprise latches to ensure they remain closed until intentionally opened, such that a perfume headspace can build-up and the consumer is able to judge the strength of the perfume based on the perfume build-up in the headspace.

Therefore, there is a need for a consumer product comprising a water-soluble unit dose article comprising a perfumed detergent composition in which strong perfume build-up in the headspace while stored in a closed position is avoided.

It was surprisingly found that a consumer product according to the present invention overcomes the above problem.

The laundry detergent composition comprises a non-soap surfactant, wherein the non-soap surfactant comprises an anionic non-soap surfactant and a non-ionic surfactant. Preferably, the laundry detergent composition comprises between 10% and 60%, more preferably between 20% and 55% by weight of the laundry detergent composition of the non-soap surfactant.

The weight ratio of non-soap anionic surfactant to nonionic surfactant is from 1:1 to 20:1, preferably from 3:1 to 17.5:1, more preferably from 5:1 to 15:1, most preferably from 7.5:1 to 12.5:1.

The non-soap anionic surfactant comprises linear alkylbenzene sulphonate, alkyl sulphate or a mixture thereof. The weight ratio of linear alkylbenzene sulphonate to alkyl sulphate is from 1:2 to 9:1, preferably from 1:1 to 7:1, more preferably from 1.25:1 to 5:1, most preferably from 1.4:1 to 3:1.

Exemplary linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear. Alkyl benzene sulfonates are well known in the art.

The alkyl sulphate anionic surfactant may comprise alkoxylated alkyl sulphate or non-alkoxylated alkyl sulphate or a mixture thereof. The alkoxylated alkyl sulphate anionic surfactant preferably is an ethoxylated alkyl sulphate anionic surfactant.

The alkyl sulphate anionic surfactant may comprise an ethoxylated alkyl sulphate anionic surfactant, preferably with a mol average degree of ethoxylation from 1 to 5, more preferably from 1 to 3, most preferably from 2 to 3.

The alkyl sulphate anionic surfactant may comprise a non-ethoxylated alkyl sulphate and an ethoxylated alkyl sulphate wherein the mol average degree of ethoxylation of the alkyl sulphate anionic surfactant is from 1 to 5, more preferably from 1 to 3, most preferably from 2 to 3.

The alkyl fraction of the alkyl sulphate anionic surfactant can preferably be derived from fatty alcohols, oxo-synthesized alcohols, guerbet alcohols, or mixtures thereof.

Preferably, the laundry detergent composition comprises between 10% and 50%, more preferably between 15% and 45%, even more preferably between 20% and 40%, most preferably between 30% and 40% by weight of the laundry detergent composition of the non-soap anionic surfactant.

Preferably, the non-ionic surfactant is selected from alcohol alkoxylate, an oxo-synthesised alcohol alkoxylate, Guerbet alcohol alkoxylates, alkyl phenol alcohol alkoxylates, or a mixture thereof.

The laundry detergent composition comprises between 0.01% and 10%, preferably between 0.01% and 8%, more preferably between 0.1% and 6%, most preferably between 0.15% and 5% by weight of the liquid laundry detergent composition of a non-ionic surfactant.

Preferably, the laundry detergent composition comprises between 1.5% and 20%, more preferably between 2% and 15%, even more preferably between 3% and 10%, most preferably between 4% and 8% by weight of the laundry detergent composition of soap, preferably a fatty acid salt, more preferably an amine neutralized fatty acid salt, wherein preferably the amine is an alkanolamine more preferably selected from monoethanolamine, diethanolamine, triethanolamine or a mixture thereof, more preferably monoethanolamine.

Preferably, the laundry detergent composition is a liquid laundry detergent composition, more preferably the liquid laundry detergent composition comprises less than 15%, more preferably less than 12% by weight of the liquid laundry detergent composition of water.

Preferably, the laundry detergent composition is a liquid laundry detergent composition comprising a non-aqueous solvent selected from 1,2-propanediol, dipropylene glycol, tripropyleneglycol, glycerol, sorbitol, polyethylene glycol or a mixture thereof. Preferably, the liquid laundry detergent composition comprises between 10% and 40%, preferably between 15% and 30% by weight of the liquid laundry detergent composition of the non-aqueous solvent.

Preferably the laundry detergent composition comprises a perfume.

Preferably, the laundry detergent composition comprises an adjunct ingredient selected from the group comprising builders including enzymes, citrate, bleach, bleach catalyst, dye, hueing dye, brightener, cleaning polymers including alkoxylated polyamines and polyethyleneimines, soil release polymer, surfactant, solvent, dye transfer inhibitors, chelant, encapsulated perfume, polycarboxylates, structurant, pH trimming agents, and mixtures thereof.

Preferably, the laundry detergent composition has a pH between 6 and 10, more preferably between 6.5 and 8.9, most preferably between 7 and 8, wherein the pH of the laundry detergent composition is measured as a 10% product concentration in demineralized water at 20° C.

When liquid, the laundry detergent composition may be Newtonian or non-Newtonian. Preferably, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition.

Those skilled in the art will know how to formulate and make a suitable detergent composition using known knowledge and techniques.

### Manufacture

Those skilled in the art will be aware of standard techniques and methods to make the consumer product according to the present invention. Those skilled in the art will be aware of methods to make the at least one water-soluble unit dose article. Those skilled in the art will be aware of standard methods to make the container. Preferably, the first part is constructed from a first blank and the second part is constructed from a second blank.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### EXAMPLES

The following are non-limiting examples according to the present invention.

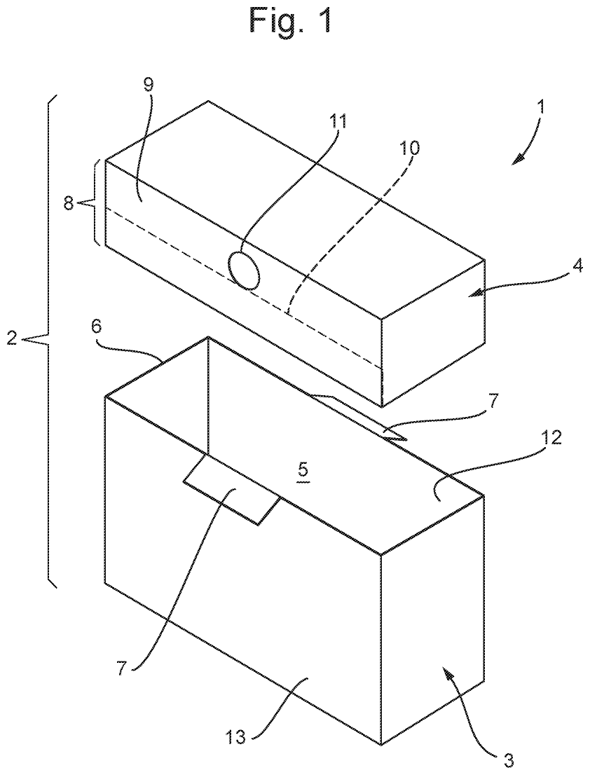

FIG. 1 depicts a consumer product (1) comprising at least one water-soluble unit dose article (not shown) and a container (2). The container (2) comprises a first part (3) and a second part (4). The second part (4) in this example is a removable lid. In FIG. 1 the container (2) is shown in the open position. The first part (3) comprises a first compartment (5) in which the at least one water-soluble unit dose article is contained (not shown), and wherein the first compartment (5) is accessible through a first opening (6). The first part (3) comprises a first locking component (7) and the second part (4) comprises a second locking component (8). In FIG. 1 the first locking component (7) is a tab made from paper-board, corrugated fibre-board or a mixture thereof. The second locking component (8) comprises an abutment (10) depicted by dotted lines and arranged on the inside surface of the at least one wall (9) of the second part (4). The abutment (10) is created by folding back the end of the at least one side wall (9) and adhering the folded back portion to the inside surface of the at least one wall (9). The second locking component (8) also comprises an opening (11) to allow the user access to disengage the first locking component (7) from the second locking component (8). The first part (3) comprises an interior surface (12) and an exterior surface (13). At least a part of the interior surface (12) is constructed from paper-based material. The container (2) in this example comprises two first locking components (7), on opposite sides of the first part (3) and two corresponding second locking components (8) on opposite sides of the second part (4).

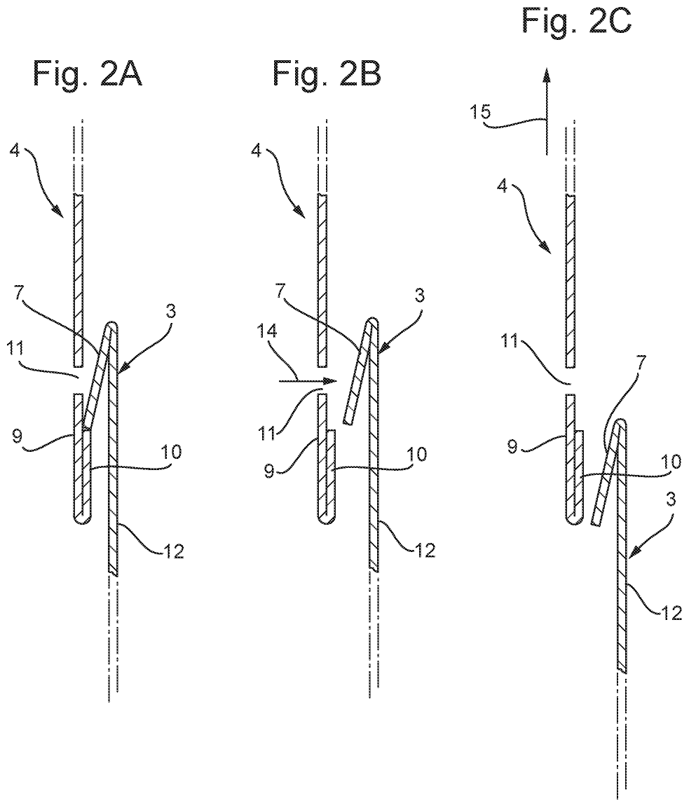

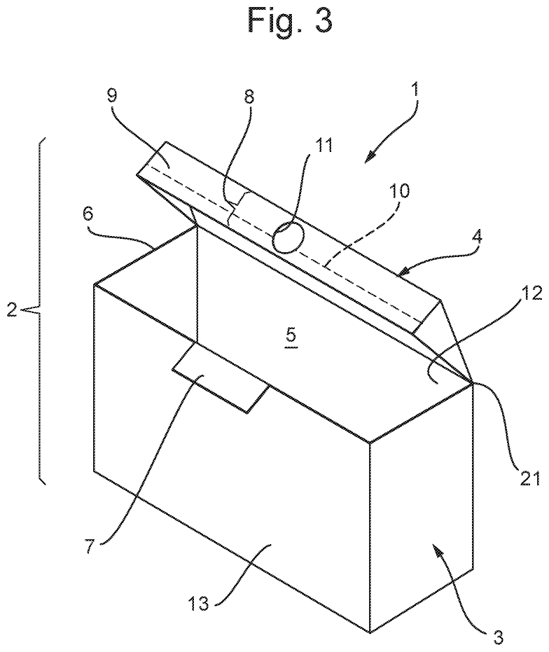

FIGS. 2A, 2B and 2C depict a cross sectional view of the container (2) of FIG. 1 In FIG. 2A the first locking component (7) is engaged with the abutment (10) of the second locking component (8). The abutment (10) is formed by folding the bottom edge of the first wall (9) back over itself and adhering the folded back portion to the inside surface of the at least first wall of the second part (9). In FIG. 2A the user disengages the first locking component (7) from the abutment (10) via application of force (14) through the opening (11). As shown in FIG. 2B, the application of force (14) displaces the first locking component (7), allowing the user to move the second part (4) away (15) from the first part (3) as shown in FIG. 2C.

FIG. 3 depicts a consumer product (1) as according to FIG. 1 but wherein the second part (4) is connected to the first part (3) via a hinge (21).

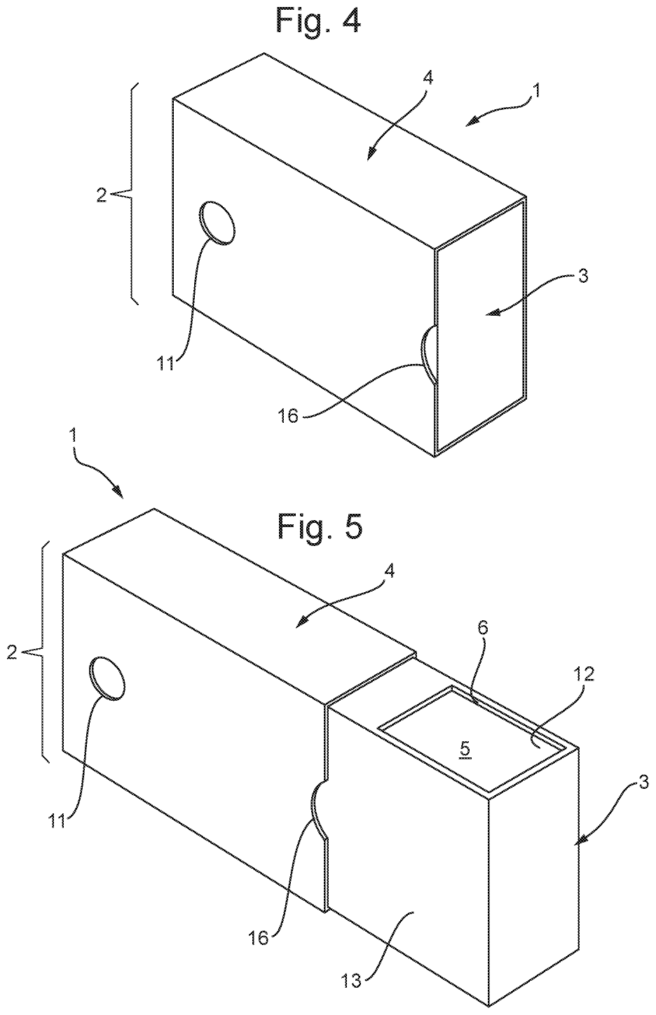

FIG. 4 depicts an alternative example according to the present invention. Depicted is a consumer product (1) comprising a container (2) and at least one water-soluble unit dose article (not shown). The container comprises a first part (3) and a second part (4). Also shown is an opening (11) for the user to disengage the first locking component (not shown) from the second locking component (not shown). The container further comprises a cut-out (16) to allow easy gripping of the first part (3) when sliding out of the second part (4).

FIG. 5 depicts the container according to FIG. 4 in an open position. Here the first part (3) has been slid out of the second part (4). The first part (3) comprises a first compartment (5) in which the at least one water-soluble unit dose article is contained (not shown), and wherein the first compartment (5) is accessible through a first opening (6). The first part (3) comprises an interior surface (12) and an exterior surface (13). At least a part of the interior surface (12) is constructed from paper-based material.

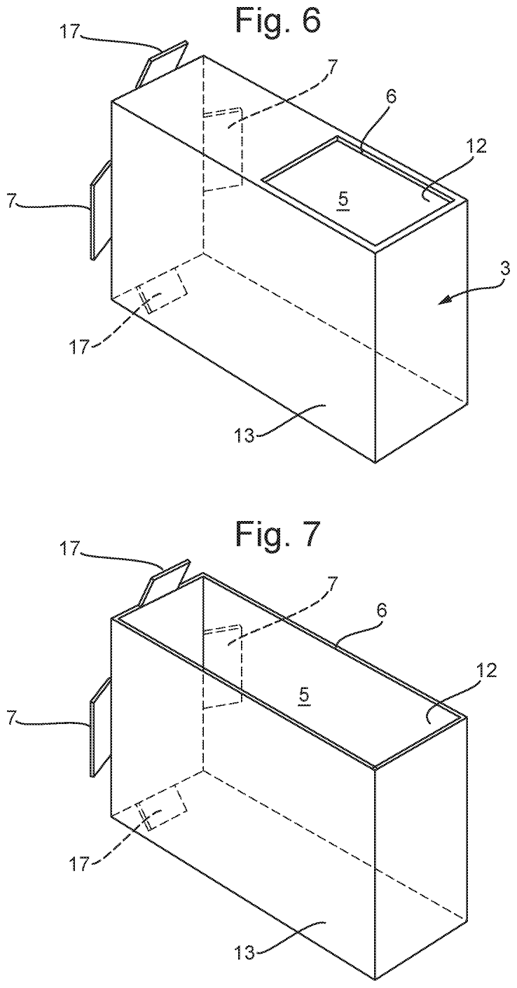

FIG. 6 depicts the first part (3) of FIGS. 4 and 5 completely removed from the second part (4). As can be seen in FIG. 6 the first part comprises two first locking components (7), one either side. In FIG. 5 the first locking component (7) is a tab made from paper-board, corrugated fibre-board or a mixture thereof. The first part (3) further comprises a stopper means (17) at the top and the bottom to prevent the first part (3) sliding completely out of the second part (4).

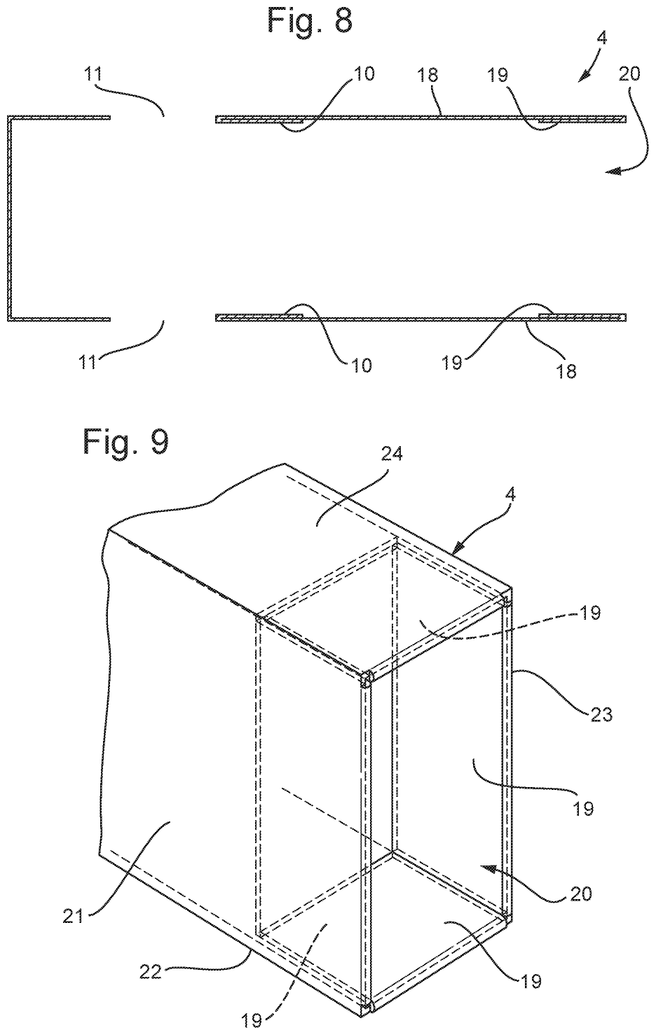

FIG. 7 depicts a first part (3) according to FIG. 5 but having a larger first opening (6). FIG. 8 depicts a top cross-sectional view of the second part (4) according to FIG. 4. The second part (4) comprises an opening (20) through which the first part (3) can slide. Further depicted are abutments (10) into which the first locking component (7) engages when in a locked position. The abutments (10) are formed by cutting a portion of the connecting wall (18) and folding said portion back upon itself and then adhering said folded back portion to the inside surface of the connecting wall (18) to create the abutment (10). Also shown is are stopper means abutment (19) formed by folding the end of the connecting wall (18) over onto itself and adhering the folded over portion to the inside surface of the connecting wall (19).

FIG. 9 depicts a 3D representation of the second part (4) according to FIG. 4. Shown are four connecting walls (21, 22, 23, 24). The stopper means abutments (19) are formed by folding over the ends of each of the four connecting walls back on themselves and adhering the folded portions to the inside surface of the respective connecting wall (21, 22, 23, 24).

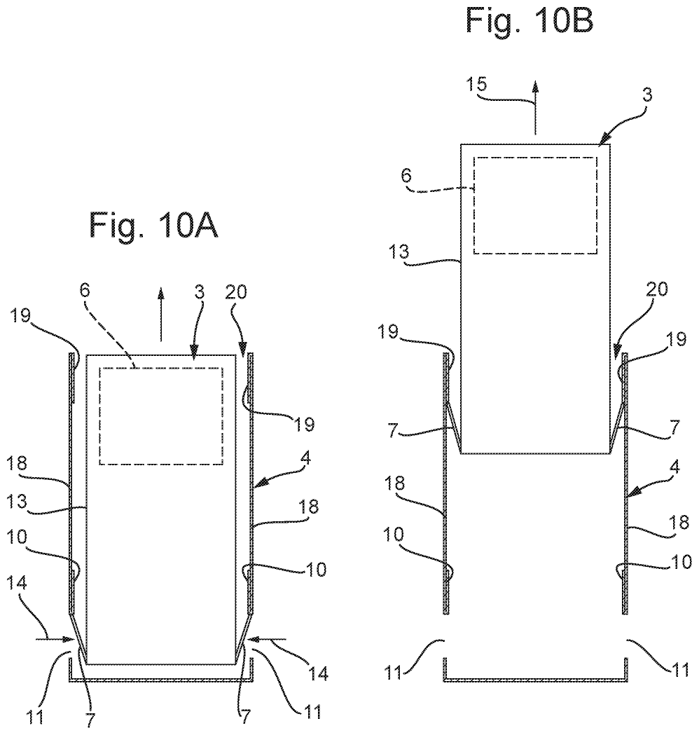

FIG. 10A and FIG. 10B depict a cross-sectional view of the consumer product (1) according to FIG. 4. In FIG. 10A the first locking component (7) is engaged with the abutment (10). The abutment (10) is formed by cutting a portion of the connecting wall (18) and folding said portion back upon itself and then adhering said folded back portion to the inside surface of the connecting wall (18) to create the abutment. The resulting hole creates the opening (11). In FIG. 2A the user disengages the first locking component (7) from the abutment (10) via application of force (14) through the opening (11). As shown in FIG. 2B, the application of force (14) displaces the first locking component (7), allowing the user to move the second part (4) away (15) from the first part (3) until the first locking component (7) abuts against the stopper abutment (19) preventing further movement. FIG. 10B depicts a cross-sectional view of the consumer product (1) in the open position.

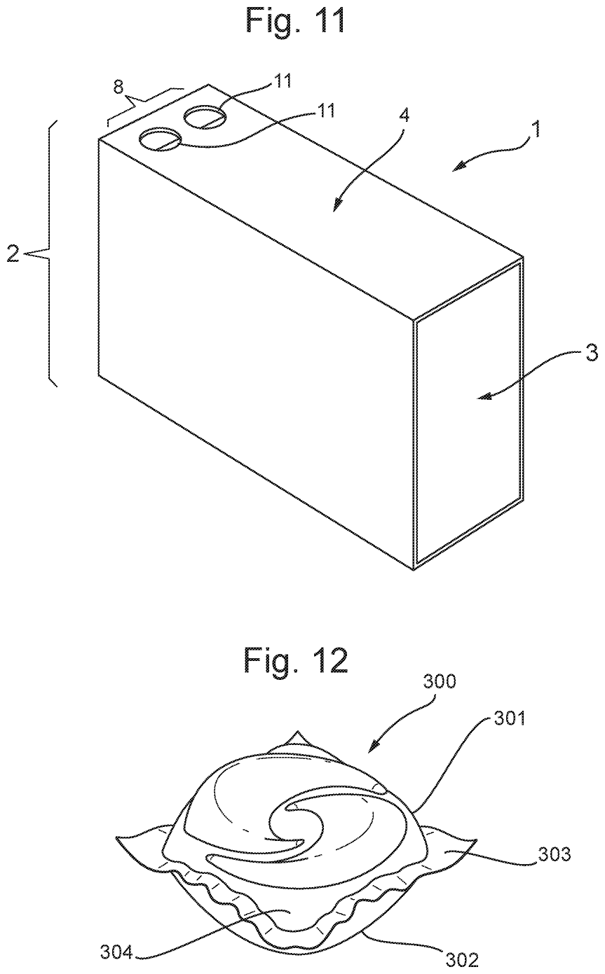

FIG. 11 depicts a consumer product (1) as according to FIGS. 4-9, 10A and 10B but wherein the second locking component (8) is in a different location, namely on the same side as the first opening (6). The first locking component (7) and second locking component (8) interact in the same way as depicted in FIG. 10. Shown are two opening (11) corresponding to two separate second locking components (8).

FIG. 12 discloses a water-soluble unit dose article according to the present invention. The water-soluble unit dose article (3) comprises a first water-soluble film (301) and a second water-soluble film (302) which are sealed together at a seal region (303). A detergent composition, preferably a laundry detergent composition (304) is comprised within the water-soluble soluble unit dose article (3).

### Example 1: Impact of Container Material on Leakage

Leakers are an ongoing complaint for Laundry soluble unit dose article consumers. Temperature shocks, especially strong temperature drops during storage exposure, have been identified as a core driver of unit dose article leakage in a storage container. In this study we cross-compared the impact of the container material in view of leakage prevention upon thermal shock exposure, more particularly paper-based containers were single variably compared versus traditional in market plastic type containers. Therefore closed packages of similar dimensions comprising 38 water soluble unit dose articles were exposed to 5 thermal shock cycles (one cycle: 7 hrs in 50° C. climate room, followed by 15 minutes in 20° C. climate room). A commercial plastic bag has also been added into the comparison. No additional mechanical action (vibration) was added during the testing. After every cycle packages were visually checked for leakers. 5 replicates of each container type were tested and the average number of leakers is reported.

### Materials:

Water soluble unit dose article: Ariel 3 in 1 Pods, as commercially available in the UK in April 2019
Plastic tub & lid: Ariel 3 in 1 Pods Polypropylene tubs & lids, as commercially available in the UK in April 2019 (dimensions: Length=250 mm; Height=135 mm; width=106 mm, count size: 38)
Plastic bags: Fairy Platinum multi-laminate (Polyethelene/Polyethylene Terephtalate) bag, as commercially available in the UK in April 2019 (dimensions: length=278 mm;
height=214 mm; width=87 mm, count size: 38)
Paper-board container (dimensions: Length=245 mm; Height=135 mm; width=96 mm, material 100% virgin fiber GN4 480 gsm commercially available from BillerudKorsnas Carry ref. BKC480, count size: 38)
Corrugated fibre-board container (dimensions: Length=245 mm; Height=135 mm; width=96 mm, material: E-flute corrugated board 382 gsm KW2 135/RF1 90/Board KW2 135, count size: 38)

### Results:

The leakage results in table 1 clearly show that unlike plastic tubs or bags, paper based containers according to the invention show absence of leakers under influence of a thermal shock exposure.

TABLE 1
Average number leaked water soluble unit
dose articles upon thermal shock cycling

| # leakers | Cycle 1 | Cycle 2 | Cycle 3 | Cycle 4 | Cycle 5 |
|---|---|---|---|---|---|
| Plastic tub | 1.4 | 3.4 | 4 | 4.2 | 4.6 |
| Plastic bag | 2 | 4.6 | 7 | 8.5 | 9.5 |
| Plainboard | 0 | 0 | 0 | 0 | 0 |
| tub | | | | | |
| Corrugated | 0 | 0 | 0 | 0 | 0 |
| paper tub | | | | | |

### Example 2: Impact of Lamination

The impact of lamination on leaker formation upon thermal shock exposure was tested by adding a paper layer (A4-80 gsm paper glued on the surface) respectively over the entire inside and over the entire outside of a 38 ct plastic polypropylene tub (as in example 1). Both legs are as such designed to have the same thermal inertia upon a thermal shock with the intent of evaluating single variable the role of a lamination layer. Both tubs were again filled with 38 pouches and exposed through 5 thermal shock cycles as described above.

### Results:

The leakage results in table 2 clearly show that while lamination of a paper based material with a secondary plastic material does not obsolete the learning ex example 1 above, it is critical when laminating to have the paper based material on the inside of the storage container.

TABLE 2
Average # leaked water soluble unit dose
articles upon thermal shock cycling

| # leakers | Cycle 1 | Cycle 2 | Cycle 3 | Cycle 4 | Cycle 5 |
|---|---|---|---|---|---|
| Paper | 2 | 4 | 4 | 4 | 5 |
| lamination | | | | | |
| outside | | | | | |
| Paper | 0 | 0 | 0 | 0 | 0 |
| lamination | | | | | |
| inside | | | | | |

### Example 3: Perfume Headspace Dependency on Container Material

Too strong perfume deposition on clothes washed with a perfumed laundry detergent composition are an ongoing complaint for Laundry soluble unit dose articles within the segment of consumers that seek avoiding an overwhelming perfume experience on their clothes. Perfume build-up in the headspace of a container upon storage is used as a signal to assess the risk of clothes getting “over”-perfumed during a wash cycle. In this study we cross-compared the impact of the storage container material in view of the perfume build-up in the headspace of the container, more particularly paper-based containers were single variably compared versus traditional in market plastic type containers.

Closed packages of similar dimensions comprising 38 water soluble unit dose articles were exposed to a 20 and a 35 days storage in a 20° C. and a 32° C. climate room after which the built-up perfume headspace has been analytically quantified. Two replicates of each container ere tested and the average total headspace number is reported.

### Materials:

Water soluble unit dose article: Ariel 3 in 1 Pods, as commercially available in the UK in April 2019
Comparative example: Plastic tubs—Ariel 3 in 1 Pods Polypropylene tubs, as commercially available in the UK in April 2019 (dimensions: Length=245 mm; Height=135 mm;
width=96 mm, count size: 38)
Example 1: Corrugated paper tub (dimensions: Length=245 mm; Height=135 mm; width=96 mm, material: E-flute corrugated board 382 gsm KW2 135/RF1 90/Board KW2 135, count size: 38)
Example 2: corrugated paper tub with PE lamination (dimensions: Length=245 mm; Height=135 mm width=96 mm, material code GD2 210/HPF 140 (E-Flute)/BKR 170+PE15

### Test Setup:

### Storage:

Two replicates of every container type were filled with 38 pouches and stored in closed position in a constant temperature climate room (20° C. and a 32° C.) for 20 days after which the perfume headspace was analytically quantified as described herein. After analytical quantification the containers were closed again and restored in the climate room for another 15 days.

### Analytical Quantification:

Stored containers were placed in open position in a sealed off plastic box and left for one hour to allow the perfume headspace to re-distribute from the container into the plastic box. Air was consequently sucked out of the box (10 min @ constant flow) through an aerosol filter capturing perfume particles from the air space. The aerosol filter was then analytically assessed using GC/MS for presence and quantification (mmol/L) of specific perfume particles. Table 3 summarizes the list of perfume materials analyzed for. The individual perfume material quantities retrieved were summed up and the resulting total headspace number has been reported.

TABLE 3
Analyzed perfume materials
Perfume materials

Cis-3-hexenol
dihydromyrcenol
allyl caproate
tetrahydrolinalool
linalool
rose oxide
phenyl ethyl alcohol
benzyl acetate
methyl phenyl carbinyl acetate
alpha-terpineol
citronellyl nitrile
citronellol
mayol
verdox
vertenex
methyl nonyl acetaldehyde
dihydro-eugenol
delta-damascone
confiran
alpha-pinyl iso-butyrate
gamma-methyl ionone
lacto-jasmon
frutene
hedione
iso e super + hexyl salicylate
peonile
ambrox
habanolide

### Results:

The total headspace results in table 4 clearly show that unlike plastic tubs, paper based containers (with or without lamination) according to the invention show a significantly lower headspace build-up upon storage.

TABLE 4
Average # perfume materials in headspace (mmol/L)

| | Storage temperature | | | | | |
|---|---|---|---|---|---|---|
| | 20° C. | | | 32° C. | | |
| | | | Comparative | | | Comparative |
| Container type | Example 1 | Example 2 | example | Example 1 | Example 2 | example |
| 20 days | 2.8 | 9.4 | 26.6 | 7.0 | 14.9 | 29.4 |
| 35 days | 2.6 | 8.5 | 23.0 | 8.4 | 14.7 | 29.9 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A consumer product comprising at least one water-soluble unit dose article and a container;
wherein the at least one water-soluble unit dose article comprises at least one water-soluble film orientated to create at least one unit dose internal compartment, wherein the at least one unit dose internal compartment comprises a detergent composition; and
wherein the container comprises a first part, wherein the first part comprises a first compartment in which the at least one water-soluble unit dose article is contained, and wherein the first compartment is accessible through a first opening; and
wherein the container comprises a second part, wherein the second part is positioned so that it prevents access through the first opening when the container is not in use, but is moveable to allow access to the first opening when the container is in use; and
wherein the container comprises a locking means wherein the locking means comprises a first locking component on the first part and a second locking component on the second part, wherein the first locking component engages the second locking component to prevent movement of the second part to allow access to the first opening until the first locking component and second locking component are disengaged from one another by a user; and
wherein the first part comprises an interior surface and an exterior surface, wherein the interior surface faces the internal compartment; and
wherein at least part of the interior surface of the first part is constructed from paper-based material so that the water-soluble film of the at least one unit dose article directly contacts the paper-based material of the internal surface.

2. The consumer product according to claim 1, wherein the detergent composition comprises a free perfume composition.

3. The consumer product according to claim 1, wherein the entire interior surface of the first part is constructed from a paper-based material.

4. The consumer product according to claim 3, wherein the whole of the first part is constructed from a paper-based material.

5. The consumer product according to claim 1, wherein the second part comprises an interior surface and an exterior surface and wherein at least part of the interior surface of the second part is constructed from a paper-based material.

6. The consumer product according to claim 5, wherein the entire second part is constructed from a paper-based material.

7. The consumer product according to claim 1, wherein;
a. the first locking component is constructed from a paper-based material; or
b. the second locking component is constructed from a paper-based material; or
c. a combination thereof.

8. The consumer product according to claim 1, wherein the paper-based material comprises paper, cardboard, or a mixture thereof.

9. The consumer product according to claim 5, wherein the paper-based material is a laminate comprising paper, cardboard, or a mixture thereof.

10. The consumer product according to claim 9, wherein the second material comprises a plastic material.

11. The consumer product according to claim 1, wherein the volume of the first compartment is between about 500 ml and about 5000 ml.

12. The consumer product according to claim 1, wherein the first locking component is a tab that protrudes from the exterior surface of the first part and wherein the second part comprises an abutment with which the first locking tab is able to releasably engage.

13. The consumer product according to claim 1, wherein the detergent composition is a liquid, a solid, or a mixture thereof.

14. The consumer product according to claim 1, wherein the water-soluble film comprises a polymer wherein the polymer comprises a homopolymer, copolymer, or mixture thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, xanthum, carragum or a mixture thereof.

15. The consumer product according to claim 1, wherein the second part is a sleeve that receives the first part therein and wherein the first part is able to slide within the second part between an open position in which the first opening is accessible and wherein the first locking component and second locking component are disengaged from one another, and a closed position in which the second part blocks access to the first opening, and wherein the first locking component and the second locking component are engaged.

16. The consumer product according to claim 15, wherein the first part comprises a base wall and the first opening, wherein the first opening is opposite to the base wall and the base wall and the first opening are connected by at least one side wall; and
the second part comprises a second opening and at least one connecting wall, wherein the first part slides within the second part via the second opening and the connecting wall blocks the first opening when in the closed; and
wherein the at least one side wall of the first part comprises the first locking component and the at least one connecting wall of the second part comprises the second locking component.

17. The consumer product according to claim 16, wherein the second part is a removable lid, wherein the second part in a closed position blocks access to the first opening and when in a closed position the first locking component is engaged with the second locking component, and when in an open position the first locking component and second locking component are disengaged and the second part is removable to allow access to the first opening.

18. The consumer product according to claim 17, wherein the second part is attached to the first part via a hinge or wherein the second part can be completely removed from the first part.

19. The consumer product according to claim 17, wherein the second part comprises a top wall and at least one side wall, and
wherein the first part comprises a base wall and the first opening, wherein the first opening is opposite to the base wall and the base wall and the first opening are connected by at least one side wall; and
wherein in the closed position the at least one side wall of the second part overlaps at least partially within the one side wall of the first part; and
wherein the first locking component is positioned on the at least one side wall of the first part and second locking component is positioned on the at least one side wall of the second part.

20. The consumer product according to claim 1, wherein the first part is constructed from a first blank and the second part is constructed from a second blank.
